(19) United States
(12) Patent Application Publication
(10) Pub. No.: US 2005/0135648 A1
(43) Pub. Date: Jun. 23, 2005

(54) Mechanical acoustic filter by erosion etching

(75) Inventor: Pei-Chau Lee, Shindian City (TW)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Knowles Electronics Taiwan, Ltd., Shindian City (TW)

(21) Appl. No.: 10/737,965

(22) Filed: Dec. 18, 2003

(51) Int. Cl. H04R 9/08; H04R 11/04; H04R 17/02

(52) U.S. Cl. 381/355; 381/357; 381/358

(57) ABSTRACT

The invention relates to a mechanical acoustic filter using erosion etching technique to be used in electric condenser microphones. The invention is to be formed as one or a plurality of boards by erosion etching according to different requirements. The boards can be of boards for printed circuit boards, ply boards, or of other materials. Every etched board has corresponding paths. which after the boards are assembled, form an acoustic filtering path that not only can extend the length of the path to filter out high frequency noise more efficiently, but also can reduce the entire volume of the microphone assembly.

### BACKGROUND OF THE INVENTION

(a) Field of the Invention

The invention relates to a new mechanical acoustic filter using erosion etching technique forming thinner boards to be used in electric condenser microphones. The invention is to be formed as one or a plurality of boards by erosion etching according to different requirements. Every etched board has corresponding path which, after the boards are assembled, form a sound filtering path.

(b) Description of the Prior Art

The conventional mechanical acoustic filters are mostly formed by injection molding technique; however, the present structures can not eliminate the short comings of acoustic filtering path being too long thus not able to reduce the entire volume of the microphone and unable to reduce high frequency noise.

### SUMMARY OF INVENTION

The invention is to provide a mechanical acoustic filter using erosion etching. The acoustic filter formed by one or a plurality of boards using erosion etching are thinner and can reduce the space occupied by the mechanical acoustic filter. The inside of the filter has a certain length of wave filtering path, which has bends and turns that efficiently extend the length of the path and can efficiently reduce high frequency noise as compared to mechanical acoustic filter formed by injection molding.

To enable a further understanding of the said objectives and the technological methods of the invention herein, the brief description of the drawings below is followed by the detailed description of the preferred embodiment.

### BRIEF DESCRIPTION OF THE DRAWINGS

FIG. 1 shows a perspective view of the entire structural combination according to the invention.

FIG. 2 shows a schematic view of the different units according to the invention.

FIG. 3 shows a side cross-sectional view of the complete assembly according to the invention.

FIG. 4 shows another perspective view of the entire structural combination according to the invention.

FIG. 5 shows another schematic view of the different units according to the invention.

FIG. 6 shows another side cross-sectional view of the complete assembly according to the invention.

FIG. 7 shows a bird's eyes view of the entire structural combination according to the invention.

FIG. 8 shows the schematic view of a preferred embodiment of the entire structural combination according to the invention.

FIG. 9 shows the best exploded view of the preferred embodiment of the entire structural combination according to the invention.

### DETAILED DESCRIPTION OF THE PREFERRED EMBODIMENTS

To better understand the characteristics and novelties of the invention, descriptions shall be given with the accompanying drawings hereunder.

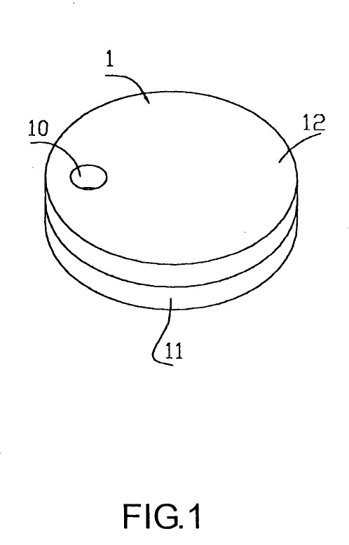

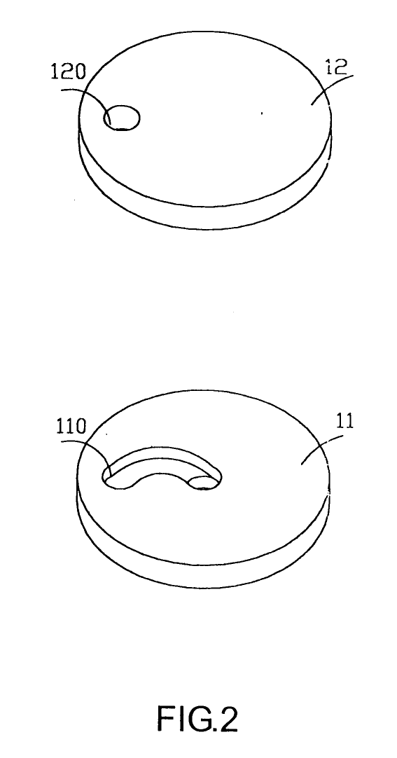

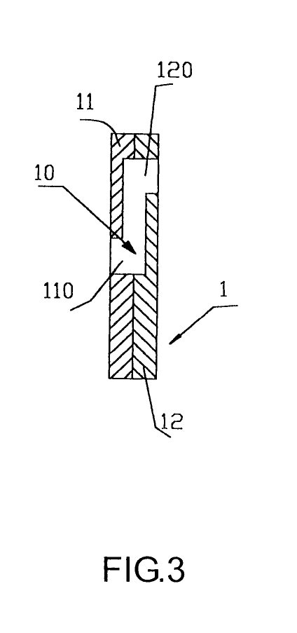

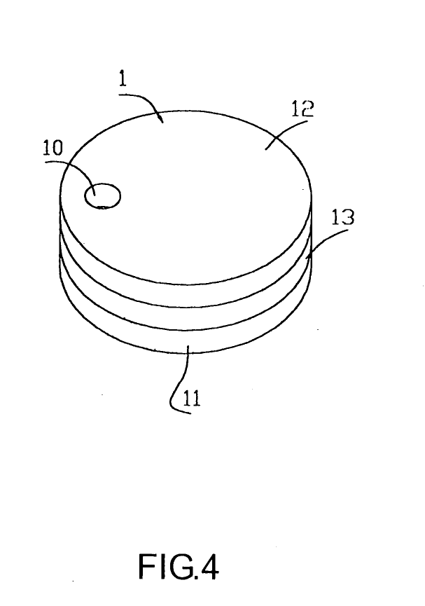

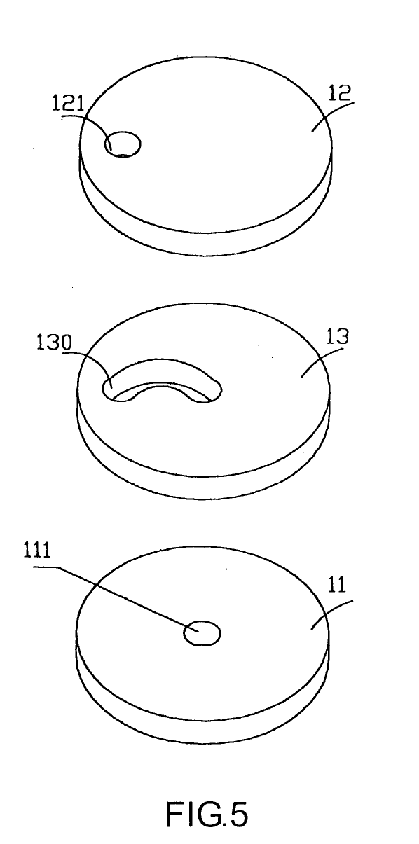

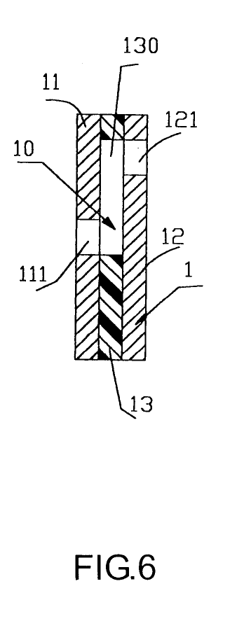

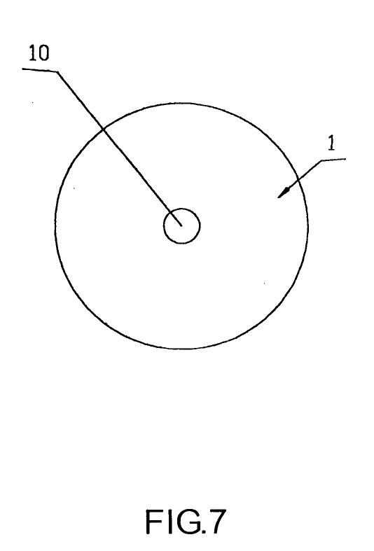

Referring to FIGS. 1-7, the invention showing a mechanical acoustic filter is a board (1) formed based on individual requirement by using erosion etching technique. The board (1) can be a single board being etched for wave filtering path (10) or a plurality of boards (1) assembled together after etching, wherein:

The board (1) can be a print circuit board, plurality boards, or made of other different materials. When the board (1) is formed from adhering two boards together (11,12), a first groove (110) is etched on a first board (11) to correspond to a second path (120) on a second board (12) resulting in a wave filtering path (10) which has an access to bend and turn in extending the path (10) efficiently.

When the board is formed from three boards (11,12,13), a third groove (130) can be etched based on need on the third board (13) to correspond to another first path (111) on the first (11) board and another second path (121) on the second (12) board. When path (111), (121), (130) are joined, a wave filtering path (10) is formed. The wave filtering path (10) also has an access to bend and turn in extending the path (10) efficiently.

When the board (1) is formed from a single board, etching is also applicable to etch out acoustic filtering path of smaller radius than that formed by injection molding.

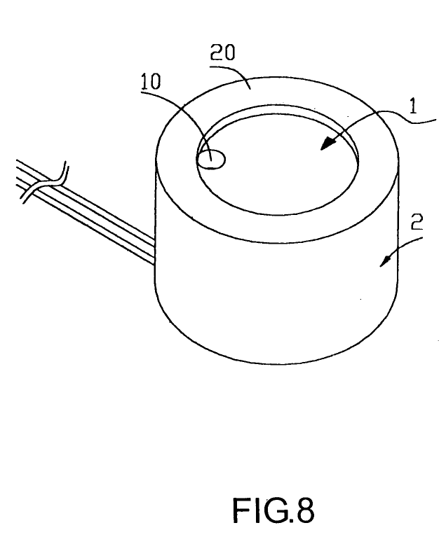

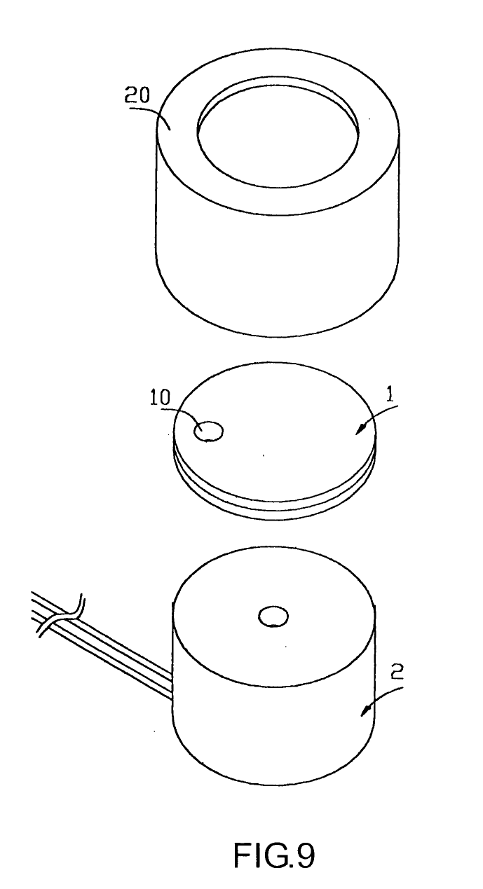

Referring to FIGS. 8-9, when installing the invention, just put the formed board (10) under a microphone (2) and cover with an affixing sponge (20) on the microphone (2).

When using the invention inside the microphone (2), due to reduced thickness of the board, the size of the microphone (2) can also be minimized.

It is of course to be understood that the embodiment described herein is merely illustrative of the principles of the invention and that a wide variety of modifications thereto may be effected by persons skilled in the art without departing from the spirit and scope of the invention as set forth in the claims.

1. A mechanical acoustic filter by erosion etching comprising:
a board formed from a plurality of individual boards using erosion etching based on individual needs, of wherein the individual board being replaced with printed circuit board, ply board and boards with different materials;
paths being etched on each individual board so when the individual boards are joined together, resulting in a wave filtering path being formed efficiently from the corresponding bending and turning grooves.

2. The mechanical acoustic filter by erosion etching as recited in claim 1, wherein at least one wave filter by erosion etching can be made on a single print circuit board by applying erosion etching.

3. The mechanical acoustic filter by erosion etching as recited in claim 1, wherein when the board is made from a single board, the radius of the wave filtering path is smaller formed by erosion etching than that formed by injection molding.
